(19) United States
(12) Patent Application Publication
(10) Pub. No.: US 2013/0068156 A1
(43) Pub. Date: Mar. 21, 2013

(54) METHOD FOR GROWING II-VI SEMICONDUCTOR CRYSTALS AND II-VI SEMICONDUCTOR LAYERS

(71) Applicant: Alex Fauler, Freiburg (DE)

(72) Inventor: Alex Fauler, Freiburg (DE)

(73) Assignee: Albert-Ludwigs-Universitaet Freiburg, Freiburg (DE)

(21) Appl. No.: 13/700,546

(22) PCT Filed: May 30, 2011
(86) PCT No.: PCT/DE11/01170

§ 371 Date: Nov. 28, 2012

(30) Foreign Application Priority Data
May 31, 2010 (DE) 10 2010 022 069.8

(51) Int. Cl. B01J 19/00

(52) U.S. Cl. CPC B01J 19/002
USPC 117/13; 117/76; 117/37; 117/54; 117/84; 117/88

(57) ABSTRACT

A method for growing II-VI semiconductor crystals and II-VI semiconductor layers as well as crystals and layers of their ternary or quaternary compounds from the liquid or gas phase is proposed. To this end, the solid starting materials are introduced into a growing chamber for the growing of crystals. Inside the growing chamber, carbon monoxide is supplied by way of reducing agent. At least certain zones of the growing chamber are heated to a temperature at which a first-order phase transition of the starting materials takes place and the starting materials pass into the liquid or gas phase. The starting materials are then cooled down accompanied by the formation of a semiconductor crystal or semiconductor layer, again with a first-order phase transition taking place. The oxygen present in the growing chamber is bound by the carbon monoxide and the formation of an oxide layer at the phase boundary of the growing semiconductor crystal or semiconductor layer is prevented.

The invention derives from a method for growing II-VI semiconductor crystals and II-VI semiconductor layers as well as crystals and layers of their ternary compounds from the liquid or gas phase.

II-VI semiconductors include semiconductors which consist on the one hand of elements from the second main group or from subgroup 12, the zinc group, and on the other hand of elements from the sixth main group of the periodic table. These include for instance CdTe, CdSe, CdS, ZnTe, ZnSe, ZnS, HgTe, HgSe, HgS and their ternary compounds (Cd, Zn)Te, Cd(Te, Se), (Hg, Cd)Te as well as their quaternary compounds such as (Cd, Zn)(Te, Se). These semiconductors are used for example in x-ray and gamma detectors, in infrared detectors, as substrates for infrared detectors, in solar cells, optical windows, optical modulators and lasers. Depending on the application, II-VI semiconductors are applied to a substrate in the form of a crystal or a thin layer. The growing methods used are melt-growth methods and gas-phase methods. These include the Bridgman method, high pressure Bridgman method, travelling heater method, travelling solvent method, modified Bridgman, Czochralski, vertical gradient freeze, zone melting technique, multi tube vapour phase transport, close space sublimation and liquid phase epitaxy.

Methods for growing II-IV semiconductor crystals and II-VI semiconductor layers and their ternary compounds from the liquid or gas phase can be found in literature.

Scheel Fukuda “Crystal Growth Technology” ISBN: 0-471-49059-8. Chapter 17, Triboulet, Siffert “CdTe and Related Compounds; Physics Defects, Hetero- and Nano-structures, Crystal Growth, Surfaces and Applications” Part II ISBN: 978-0-08-096513-0,

Rudolph “Fundamental Studies on Bridgman Growth of CdTe” in progress, in Crystal Growth and Characterization Vol. 29 275-381 and

“Semiconductors for Room Temperature Nuclear Detectors” in the series Semiconductors and Semimetals Vol. 43. Chapter 6.

The purest materials available for growing semiconductor crystals contain oxygen and carbon as the principal impurities. When preparing the growing container with the growing chamber and adding the starting materials to the growing container, there is moreover the risk of oxidation on the surfaces. This results on the one hand in oxygen being incorporated into the crystal lattice, thus adversely influencing the electrical properties of the crystal. On the other hand a layer enriched with oxygen forms before the growth boundary during growth from the melt or from the molten solutions of the starting materials. This adversely influences the transport properties of other elements in the melt, especially in the diffusion boundary layer, along with the wetting properties of the melt. inclusions and inhomogeneities of the crystal's electrical properties are the result.

A method is known from the publication U.S. 2010/0080750 A1 where H₂ or gas mixtures containing H₂ are introduced into the reactor container or the container is rinsed with these during the synthesis of CdTe from the starting materials. Unlike the subject of the patent application, this method concerns the synthesis and cleaning of CdTe rather than the growing of crystals. The disadvantage of this approach is that other elements of the sixth main group as well as oxygen react with hydrogen. In the case of open systems, for example, this can result in the removal of that component. A further disadvantage is that at high temperatures (>1000° C.), H₂ diffuses to a significant extent even through quartz glass. This is a problem, given the typical growing times of several weeks for growth from a melt and half-lives of several tens of hours.

A method for the synthesis of semiconductor materials involving the use of hydrogen is known from CA 2510415 A1. That publication, too, refers merely to synthesis and not the growing of crystals. The disadvantages are the same as in U.S. 2010/0080750 A1.

The invention is based on the task of providing a method for growing II-VI semiconductors and their ternary and quaternary compounds with which the oxygen can be bound.

This objective is achieved by a method having the features of claim 1. The method is characterised in that carbon monoxide which binds the oxygen is supplied in a growing chamber for the growing of crystals. The carbon monoxide supplied reacts with the oxygen to form carbon dioxide. The carbon monoxide reduces the oxides of the starting materials which are introduced into the growing chamber for growing the II-VI semiconductors. Any other oxygen that is present in the growing chamber is also bound. This technique prevents an oxygen-enriched layer from forming at the semiconductor's growth boundary during growing. Particularly the oxides at the phase boundary of the growing semiconductor crystal result in impaired properties. The oxygen in the growing chamber is bound by the carbon monoxide, preventing the formation of a layer enriched with oxides of the starting materials at the growth boundary. When growing semiconductors with cadmium or zinc, for example, the oxides present in the starting materials cadmium or zinc react as follows:

CdO+CO Cd→CO₂

ZnO+CO→Zn+CO₂.

Unlike the methods known from prior art, the method according to the invention does not involve any synthesis or tempering of a II-VI semiconductor; rather, a II-VI semiconductor crystal or a II-VI semiconductor layer is produced from the melt of starting materials or by the deposition of the gaseous starting materials. To that end, first the starting materials are introduced into the growing chamber in solid form. The starting materials are on the one hand one or more elements from the second main group or from subgroup 12, the zinc group, and on the other hand one or more elements from the sixth main group of the periodic table. Carbon monoxide is in addition supplied in the growing chamber. At least certain zones of the growing chamber are heated to a temperature above the melt temperature of the starting materials or to a temperature at which the starting materials exhibit an adequate gas pressure for the gaseous state of aggregation. As a result the starting materials pass from the solid to the liquid or gas phase. A first-order phase transition thus takes place. The starting materials are then deliberately cooled down so that a II-VI semiconductor crystal or a crystalline II-VI semiconductor layer forms. A further first-order phase transition now takes place. The II-VI semiconductor material passes from the liquid or gaseous state into a solid state.

Heating-up of the starting materials and deliberate cooling-down may take place according to one of the known melt-growth methods and gas-phase methods. These include the Bridgman method, high pressure Bridgman method, travelling heater method, travelling solvent method, modified Bridgman, Czochralski, vertical gradient freeze, zone melting technique, multi tube vapour phase transport, close space sublimation and liquid phase epitaxy. The growing of the II-VI semiconductor crystal or II-VI semiconductor layer can take place in enclosed, semi-open or open growing chambers or growing apparatus.

If the growing chamber is enclosed, first the starting materials are introduced into the growing chamber while it is still open. Then either the carbon monoxide or one or more substances that form carbon monoxide in the growing chamber are introduced into the still-open growing chamber. The growing chamber is then sealed gas-tight. The growing chamber is only heated up once it has been sealed. The growing chamber is typically not opened until crystal growing has finished. The enclosed growing chamber may for example be an ampoule. In order to withstand the high temperatures to which the growing chamber is heated during crystal formation, the ampoule is made of quartz glass for example.

There are two options for supplying the carbon monoxide: either carbon monoxide is introduced into the growing chamber or one or more carbon monoxide starting materials from which carbon monoxide is produced by reaction inside the growing chamber are introduced into the growing chamber. The introduction of carbon monoxide offers the advantage that the required amount can be supplied, but strict safety precautions when handling carbon monoxide need to be taken in view of its toxicity. Instead of carbon monoxide, the carbon monoxide starting materials carbon dioxide and carbon can be introduced into the growing chamber. At the temperature prevailing inside the growing chamber, carbon and carbon dioxide react to form carbon monoxide. Alternatively carbon and oxygen or carbon and water vapour can be introduced into the growing chamber as carbon monoxide starting materials. The formation of carbon monoxide is promoted by the high temperatures inside the growing chamber. The carbon may also come from the starting materials that are introduced into the growing chamber for growing, or it may be introduced separately into the growing chamber.

The carbon monoxide supplied is not one of the starting materials for the growing process, because it is not itself used in growing the semiconductor, The materials from which carbon monoxide is produced in the growing chamber are therefore referred to as carbon monoxide starting materials.

If the incorporation of carbon into the crystal lattice is desired as a form of doping and not enough carbon is available for doping due to the reaction between carbon and carbon dioxide that produces carbon monoxide, co-doping involving one or more other dopants may be performed. If for instance a high-ohmic crystal or high-ohmic layer is to be grown, tin, germanium, chlorine and/or indium are suitable for doping. Doping of the semiconductors is moreover not influenced by the method according to the invention.

According to an advantageous embodiment of the invention, the carbon monoxide is supplied at the phase boundary of the crystal being formed. It is thus supplied at precisely the point where it is needed in the growing process. If it is not possible to position the carbon monoxide precisely, for example by its targeted introduction into the growing chamber, the carbon monoxide may also be distributed throughout the entire growing chamber. The semiconductor may also be doped with carbon monoxide or carbon dioxide for the method according to the invention, if appropriate.

According to a further advantageous embodiment of the invention, carbon monoxide is introduced into the growing chamber. In an enclosed system, this may take the form of the carbon monoxide being introduced into the growing chamber together with the starting materials, and possibly other materials, before it is sealed. Upon sealing, the growing chamber is insulated from its surroundings. In an open system, the carbon monoxide may be introduced into the growing chamber in the form of a gas flow.

According to a further advantageous embodiment of the invention, carbon dioxide is introduced into a growing chamber for the growing of crystals. Carbon monoxide is supplied to the growing chamber by the conversion of carbon dioxide into carbon monoxide in the presence of carbon at the high temperatures prevailing in the growing chamber. The carbon may come either from the starting materials that contain carbon as an impurity or be introduced into the growing chamber in the form of an additive. In an enclosed system, the carbon dioxide supply may take the form of carbon dioxide introduced into the growing chamber together with the starting materials, and possibly other materials, before it is sealed. In an open system, the carbon dioxide may be introduced into the growing chamber in the form of a gas flow.

Boudouard's equilibrium for the reaction

CO₂+C→2CO

shifts increasingly to the right-hand side as the temperature rises. High temperatures which favour the formation of carbon monoxide prevail in the growing chamber during growth of the semiconductor.

If for example cadmium or zinc oxide is reduced:

CdO+CO→Cd+CO₂

ZnO+CO→Zn+CO₂.

the carbon dioxide produced is available for the further reduction of CdO and ZnO due to its reaction with carbon in accordance with the above reaction equation.

According to a further advantageous embodiment of the invention a surface exhibiting carbon is heated up in the growing chamber and a gas flow containing carbon dioxide is passed over the surface. This results in the formation of carbon monoxide. The surface may be part of the growing chamber, for example a wall. The growing chamber here is part of an open system.

According to a further advantageous embodiment of the invention, the inside of the growing chamber is coated with carbon. The carbon may be applied for example in the form of graphite for coating.

According to a further advantageous embodiment of the invention, a graphite crucible is inserted in the growing chamber to hold one or more starting materials. This ensures that sufficient carbon is available. The crucible may either be made from carbon or be coated with carbon.

According to a further advantageous embodiment of the invention a surface exhibiting carbon is heated up and a gas flow of oxygen is passed over the surface. Carbon monoxide is formed, binding the unwanted oxygen.

According to a further advantageous embodiment of the invention a surface exhibiting carbon is heated up and a gas flow containing water vapour is passed over the surface. Carbon monoxide forms as a result of the high temperatures in the growing chamber, binding the unwanted oxygen and thus acting as a reducing agent for the oxides of the starting materials.

According to a further advantageous embodiment of the invention an inert gas is introduced into the growing chamber in order to increase the gas pressure over the melt. This prevents the formation of bubbles close to the phase boundary, where these could occur as a result of an enrichment of carbon dioxide or through the formation of carbon monoxide according to Boudouard's equilibrium.

Further advantages and an advantageous configuration of the invention can be obtained from the following model embodiments and the claims.

### MODEL EMBODIMENT 1

In order to grow a CdTe semiconductor crystal using the vertical Bridgman method, pre-synthesized stoichiometric CdTe or cadmium and tellurium bars are weighed out in a stoichiometric ratio in a graphited quartz glass ampoule acting as the growing chamber. A dopant and a possibly intentional excess of cadmium or tellurium are added to the ampoule. Carbon monoxide or carbon dioxide are introduced into the evacuated ampoule up to a pressure of 0.05 to 50 mbar. The ampoule is then sealed gas-tight with a quartz glass cap. This is an enclosed system. The congruent melting point of CdTe is 1092° C. The ampoule is heated up in a suitable oven in the overheating phase to more than approx, 1120-1150° C. and then lowered relative to the oven on a temperature gradient of approx. 10°/cm by typically between a few millimetres and 20 mm per day. The solid/liquid phase boundary is close to the 1092° C. isotherm throughout this time. The area around the melt, which is in the direct vicinity of the phase boundary throughout the growing phase, is kept free of oxides by the carbon monoxide in the growing chamber, assuring the unhindered passage of Cd and Te material and of the dopant to the phase boundary and the growth boundary of the semiconductor crystal, or away from the latter.

### MODEL EMBODIMENT 2

For the manufacture of CdTe thin-film solar cells in the superstrate configuration a glass substrate is coated with a transparent, conductive oxide such as ITO (indium tin oxide). First CdS and then CdTe are deposited on this from the gas phase. To that end, pre-synthesized, solid CdTe is heated to temperatures of typically 500-600° C. at a distance of a few centimetres from the substrate and sublimated. The gaseous CdTe is deposited on the colder substrate and is resublimated. This crystal growing method is referred to as close space sublimation. Carbon monoxide is introduced into the space between the source and the substrate. This prevents CdO from being deposited on the growing substrate.

### MODEL EMBODIMENT 3

For growing crystals according to the travelling heater method, an ideally monocrystalline seed crystal of CdTe or (Cd,Zn)Te is positioned at the lower end of a graphited quartz glass ampoule. The inside of the quartz glass ampoule is coated with graphite. A compact piece of tellurium and the desired dopant are arranged above this seed crystal. Above this area there is a compact piece of CdTe or (Cd,Zn)Te by way of feed material. The tellurium is melted down (449° C.) by means of a ring-shaped heating device that has approximately the same axial extension as the piece of tellurium. If the temperature is increased further to 750-950° C., according to the phase diagrams the CdTe or (Cd,Zn)Te in this zone dissolve, increasing the group II content to approx. 20-30%. The ring-shaped heating device is now moved upwards relative to the growing ampoule. This movement prompts monocrystalline (Cd,Zn)Te or CdTe to crystallise at the lower end of the tellurium-rich zone, and feed material to dissolve at the upper end. If this method is carried out with carbon monoxide in the enclosed ampoule, oxide-rich material in the melt is prevented from being enriched directly in front of the crystal's growth front. This improves transport of Cd or Cd and Zn through the tellurium-rich zone from the feed material to the growing crystal.

All features of the invention can be material to the invention both individually and in any combination.

1. Method for growing II-VI semiconductor crystals and II-VI semiconductor layers as well as crystals and layers of their ternary and quaternary compounds from the liquid or gas phase, wherein
the solid starting materials are introduced into a growing chamber for the growing of crystals,
the reduction agents carbon monoxide and/or carbon monoxide starting materials from which carbon monoxide is produced by reaction inside the growing chamber are supplied inside the growing chamber,
at least certain zones of the growing chamber are heated to a temperature at which a first-order phase transition of the starting materials takes place and the starting materials pass into the liquid or gas phase,
the starting materials are cooled down accompanied by the formation of a semiconductor crystal or semiconductor layer, again with a first-order phase transition taking place, the oxygen present in the growing chamber is bound by the carbon monoxide and the formation of an oxide layer at the phase boundary of the growing semiconductor crystal or semiconductor layer is prevented.

2. Method according to claim 1, wherein the carbon monoxide is supplied at the phase boundary of the crystal being formed.

3. Method according to claim 1, wherein carbon monoxide is introduced into the growing chamber.

4. Method according to claim 3, wherein the carbon monoxide is led through the growing chamber as a gas flow.

5. Method according to claim 3, wherein the carbon monoxide is added to the growing chamber together with the starting materials for the growing of crystals and the growing chamber is then sealed.

6. Method according to claim 1, wherein carbon dioxide and carbon are added to the growing chamber for the growing of crystals, in order to supply carbon monoxide; carbon monoxide is then obtained from the carbon dioxide and carbon in the growing chamber by reaction.

7. Method according to claim 6, wherein the carbon dioxide is led through the growing chamber as a gas flow.

8. Method according to claim 7, wherein a surface exhibiting carbon is heated up, and wherein the flow of carbon dioxide is passed over the surface.

9. Method according to claim 6, wherein the carbon dioxide is added to the growing chamber together with the starting materials for the growing of crystals and the growing chamber is then sealed.

10. Method according to claim 9, wherein the inside of the growing chamber is coated with carbon.

11. Method according to claim 9, wherein a graphite crucible is placed inside the growing chamber.

12. Method according to claim 1, wherein in order to supply carbon monoxide in the growing chamber a surface exhibiting carbon is heated up, and wherein a gas flow of oxygen is passed over the surface.

13. Method according to claim 1, wherein an inert gas is introduced into the growing chamber.
